(19) United States
(12) Patent Application Publication
(10) Pub. No.: US 2015/0134374 A1
(43) Pub. Date: May 14, 2015

(54) SYSTEMS AND METHODS FOR MULTIPLE SERVICE CHECK-IN THROUGH A SINGLE SERVICE CENTER CHECK-IN

(71) Applicants: Egan Schulz, San Jose, CA (US); Michelle Serrano, San Jose, CA (US); Libo Su, San Jose, CA (US); Kamal Zamer, Austin, TX (US)

(72) Inventors: Egan Schulz, San Jose, CA (US); Michelle Serrano, San Jose, CA (US); Libo Su, San Jose, CA (US); Kamal Zamer, Austin, TX (US)

(21) Appl. No.: 14/141,093

(22) Filed: Dec. 26, 2013

Related U.S. Application Data
(60) Provisional application No. 61/903,664, filed on Nov. 13, 2013.

(51) Int. Cl. G06Q 10/02; H04W 4/00

(52) U.S. Cl. CPC G06Q 10/02; H04W 4/008
USPC 705/5

(57) ABSTRACT

There are provided systems and method for multiple service check-in through a single service center check-in. A user may utilize a user device to check-in to a service center, such as a mall, airport, or hotel, offering a plurality of services. As the user moves throughout the service center, the user device may connect to beacons, such as Bluetooth Low Energy beacons. The user device may be previously checked-in with these beacons, or may be quickly checked-in when in proximity to the beacons without the user checking-in to each beacon manually. Thus, if the user is in proximity to a service, the user device may receive advertisements, information, etc. for the service. Additionally, since the user will already be checked-in to the service, the merchant and/or service center may complete transactions for the user with the service.

### CROSS-REFERENCE TO RELATED APPLICATIONS

Pursuant to 35 U.S.C. §119(e), this application claims priority to the filing date of U.S. Provisional Patent Application Ser. No. 61/903,664, filed Nov. 13, 2013, which is incorporated by reference in its entirety.

### TECHNICAL FIELD

The present application generally relates to multiple service check-in through a single service center check-in and more specifically to a single check-in between a user device and a service center server that enables check-in with all of the services at the service center.

### BACKGROUND

Consumers may visit service centers, such as retail locations, shopping malls, strip malls, large department stores, airports, hotels, or other locations having more than one service to the consumers. The user may utilize applications with the services to receive sales, discounts, or other advertisements. Additionally, the application may assist a user in completing a payment with the service by enabling the user to utilize a user device to complete the payment. The consumer may further utilize a payment provider to complete the payments. However, if the consumer wishes to make payments quickly or is traveling through an area with a large amount of merchants, the user may forego utilizing payment applications for each individual merchant due to time constraints and/or required number of inputs. Moreover, if a consumer is merely browsing through a service center, the user may not be aware of preferred merchants located throughout the service center. The merchant may also be unaware of the consumer to offer items, advertisements, or other offerings to the consumer.

### BRIEF DESCRIPTION OF THE DRAWINGS

FIG. 1 is a block diagram of a networked system suitable for implementing the processes described herein, according to an embodiment;

FIG. 2A is an exemplary server including information used to check-in a user with multiple services, according to an embodiment;

FIG. 2B is block diagram of an exemplary service center displaying two users checked-in to multiple services through a single check-in with a service center server, according to an embodiment;

FIG. 3 is a flowchart of an exemplary process by a service center server for completing a check-in for multiple services, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A service center may offer a single check-in service that checks the user in to each service at the service center. A service center may correspond to a shopping mall, airport, hotel or the like, where a plurality of services offers items, products, services, etc. to users. In various embodiments, the service center may correspond to a location offering merchant and merchant services to the user. A user may visit the service center and check in directly with the service center. The check-in may be completed prior to or while visiting the service center using an Internet connection with the service center server, or using a short range wireless beacon connection at the service center, such as one offered through a beacon of the service center. Once check-in with the service center is completed, the service center may check the user in to each merchant and/or service offered at the service center.

Various locations, such as the service center and/or services inside the service center, may provide short range wireless communications with a user device, such as through Bluetooth Low Energy (BLE) beacon communications. These beacons may be set up at a location and communicate with the user device to alert users of check-in services through their user device. Additionally, the beacons may provide communication services to the user device directly, including information stored on the beacons, and/or information from a device or server corresponding to the beacon.

As the user moves through the service center, these wireless beacons at the services may determine if the user is in proximity to the service through a short range wireless communication, such as Bluetooth Low Energy. Since the user has previously completed a check-in with the service center, a check-in may be completed with the service previously or when the user device is in proximity to the beacon without the user being required to complete a check-in at each service.

If the user is in proximity to a specific service, the service center may assist the user in completing a transaction with the service. Transactions the user may engage in may correspond to a payment for an item at a merchant, or may correspond to informational exchanges, updates, etc. that a service may offer. Since the user has previously checked-in with the service center, further check-in with the specific service is not required by the user and is completed by the service center instead.

Based on the transactions and/or visited locations of the user, a user history may be developed, where the user history has preferred services. The history may also include information the user has uploaded and/or selected preferences of the user. A server of the service center may also further develop the history through scraping online content, account linking, or other user investigative processes. The preferred services may then be determined when the user visits the service center, and the user may receive updates concerning the preferred services. The updates may include locations of the preferred service, advertisements, discounts, etc. Where the user is utilizing one of the services at the service center, such as a plane, train, or other transportation service, the user may receive updates on the service, which may be user specific and/or general to the service.

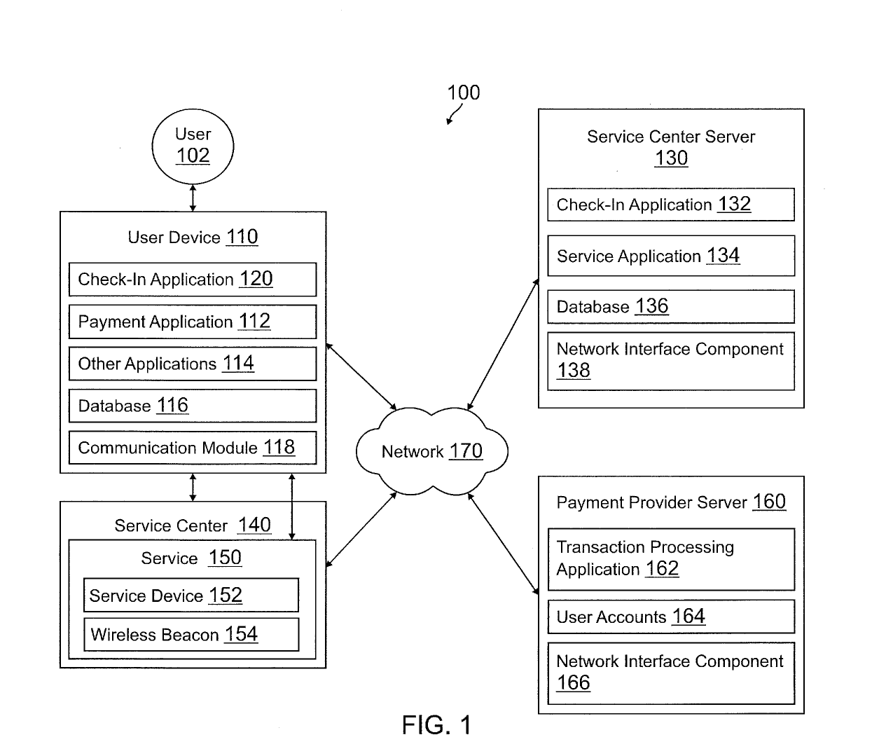

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a service center server 130, a service center 140 having service 150, and payment provider server 160 in communication over a network 170. User 102, such as a consumer, may utilize user device 110 to check-in to service center server 130. Service center server 130 may correspond to a general server for multiple service centers (e.g. a server for a chain shopping mall provider) or may be specific to only service center 140 (e.g. a server for a specific airport branch, strip mall, etc.). Once user 102 is checked-in to service center server 130, the user may be automatically checked-in to service 150 at service center 140. The check-in may be completed automatically with each service or only based on the proximity of user 102 to service 150. Once the user is in proximity to service 150, a transaction between user 102 and service 150 may be completed using payment provider server 160.

User device 110, service center server 130, service center 140, service 150, and payment provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication with merchant 130, wireless beacon 154, and/or payment provider server 160. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 120, a payment application 112, other applications 114, a database 116, and a communication module 118. Check-in application 120, payment application 112, and other applications 114 may correspond to processes, procedures, and/or applications executable by a hardware processor, for example, a software program. In other embodiments, user device 110 may include additional or different software as required.

Check-in application 120 may be used by user 102 of user device 110 to establish a connection between user device 110 and service center server 130. Check-in application 120 may correspond to a specific application utilized by user device 110 with service center server 130 to complete a single check-in with service center server 130. The single check-in with service center server 130 may correspond to a processes to log in to a user account of user 102 with service center server 130 or otherwise provide and verify identity of user 102, including transmission of an identifier for a payment account with payment provider server 160. The single check-in may be completed over an Internet connection over network 170 with service center server 130. In such embodiments, check-in application 120 may correspond more generally to a browser application configured to communicate with service center server 130.

Check-in application 120 may also correspond to an application available over the Internet for download from service center server 130, payment service provider 150, and/or a merchant/service server corresponding to service 150. In such embodiments, check-in application may complete a single check-in using a wireless beacon at service center 140. Check-in application 120 may be set up to receive short range wireless communications with the wireless beacon at service center server 130 to complete the check-in process. For example, service center 140 may include infrastructure with wireless beacons to communicate with user device 110 and complete the check-in process with service center server 130.

Additionally, check-in application may communicate with wireless beacon 154 at service 150. In such embodiments, check-in application 120 of user device 110 may utilize short range wireless communication with service device 152, such as near field communication, Bluetooth, Bluetooth Low Energy, radio, infrared, or other connection.

Once check-in application 120 has completed a connection with service center server 130, user device 110 may be checked-in to all or nearby merchants/service at service center 140, as will be discussed in more detail herein. Check-in application 120 may be further utilized to receive and/or transmit information to wireless beacons 142 of service 150. For example, check-in application may execute in the background of an operating system of user device 110 and be configured to establish connections, using communication module 118 of user device 110, with wireless beacon 154. The connection may be established with or without user input from user 102. For example, wireless beacon 154 may broadcast a token, such as a universally unique identifier (UUID), for reception by check-in application 112, as will be explained in more detail herein. Check-in application 112 may utilize communication module 118 of user device 110 to receive the token from wireless beacon 154. If check-in application 112 acknowledges the UUID as identifying service center server 130, service center 140, and/or wireless beacon 154, check-in application 112 may transmit an identifier corresponding to user 102 and/or user device 110 back to wireless beacon 154. Check-in application 112 may utilize communication module 118 of user device 110 to communicate with wireless beacon 154 (e.g., over near field communication, Bluetooth, Bluetooth Low Energy, radio, infrared, or other connection). The identifier from user device 110 may include, be transmitted with, concatenated with, or otherwise bundled with the identifier received from wireless beacon 154. Once a connection is established with wireless beacon 154, user device 110 may be checked-in with that particular merchant through service center server 130 (e.g., using the initial check-in with service center server 130) if user 102 has not previously been checked-in.

Check-in application 120 may receive information from service center server 130 and/or service 150. For example, check-in application 120 may receive advertisements, updates, or other information corresponding to a merchant and/or service at service center 140. The information may be passed to check-in application 120 based on a proximity of user 102 to service 150, based on a user history (e.g. transaction history, purchase history, etc.), or may be generally transmitted to user 102 based on available merchants/services at service center 140. Since user 102 is already checked-in with service 150, service 150 may know an identifier of user device 110 and transmit the advertisement information to user device 110 using that identifier.

Check-in application 120 may utilize communication module 118 to pass information to service center server 130, service 150, and/or payment provider server 160 as well. For example, once a check-in is completed through service center server 130, check-in application 120 may pass information to service center server 130, service 150, and/or payment provider server 160 to complete a transaction. In certain embodiments, the information may correspond to a selected item for purchase, a requested service and/or service information, or other potential merchant/service transaction available at service center 140. Payment for an item may then be completed through payment application 112 utilizing payment provider server 160.

Payment application 112 may be used, for example, to provide a convenient interface to permit user 102 to select payment options and provide payment for items and/or services. For example, payment application 112 may be implemented as an application having a user interface enabling the user to enter payment options for storage by user device 110, provide payment options on checkout/payment of an item/service, and complete a transaction for the item/service. In some embodiments, payment application 112 may correspond more generally to a web browser configured to view information available over the Internet or access a website corresponding to a payment application. Payment application 112 may utilize user financial information, such as a credit card, bank account, or other financial account. Additionally, payment application 112 may provide payment for items using a user account with payment provider, such as payment provider server 160. Payment application 112 may further include options to store transaction history for purchased items, such as receipts, for later use. Thus, payment application 112 provides an interface enabling user 102 to provide proof of purchase of an item to a merchant.

Once user 102 has checked-in with service center server 130, user device 110 may establish a connection with service 150 in proximity to user 102 and “automatically” check-in with service 150 without further user input. Payment application 112 may then populate payment infolination transmitted to user device 110 from service 150. For example, payment application 112 may receive a request to pay for items/services at service 150. Since user 102 is already checked-in with service 150, service 150 may know an identifier of user device 110 and transmit the transaction information to user device 110 using that identifier.

Payment application 112 may be utilized to complete the transaction between user device 110 and service 150 by providing payment for items and/or service at service 150. Payment can be provided from payment provider server 160, for example, though a payment account of user 102 with payment provider server 160. Service center server 130 may be utilized to assist in completing the payment between user device 110 and service 150. In various embodiments, the server accepting the payment may transmit a transaction history documenting completion of the transaction. Thus, user 102 may pick up items and/or redeem services at service 150 using the transaction history or other payment authorization service 150.

In various embodiments, check-in application 120 and/or payment application 112 may be incorporated in the same application so as to provide their respective features in one application interface.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with payment provider server 140. Other applications 114 may include browser applications, where the functions are not provided by check-in application 120 and/or payment application 112. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 120, payment application 112, and/or other applications 114, identifiers associated with hardware of user device 110, or other appropriate identifiers, such as identifiers used for payment/user/device authentication or identification. Database 116 may include user device tokens and/or encryption keys, including a public key of service 150 for wireless beacon 154. Database 116 may include identifying information for merchant tokens enabling check-in application 120 to identify service 150 when receiving a corresponding token. In one embodiment, identifiers in database 116 may be used by a payment/credit provider, such as payment provider server 160, to associate user device 110 with a particular account maintained by the payment/credit provider. Database 116 may further include online account access information.

User device 110 includes at least one communication module 118 adapted to communicate with service center server 130, wireless beacon 154, and/or payment provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 154 without network 170.

Service center server 130 may be maintained, for example, by a service center including a plurality of merchant and/or service physical locations. Generally, service center server 130 may be maintained by anyone or any entity that establishes a group of merchants and/or services. In this regard, service center server 130 may include one or more applications, which may be configured to interact with user device 110 and/or service 150 at service center 140 to complete check-in processes with service 150. Service center server 130 may be further configured to create and/or utilize a history of visits, transactions, and/or preferences of user 102 for use in transmitting advertisements, updates, etc. Additionally, service center server 130 may facilitate the exchange of money and the transmission of transaction histories between user device 110 and service 150 using payment provider server 160. Although only one service center server is shown, a plurality oft servers may be utilized. In various embodiments, the check-in, advertisement, update, and payment services of service center server 130 may also be offered by a payment provider, such as payment provider server 160. Thus, the described processes and features of service center server 130 may be incorporated within payment provider server 160.

Service center server 130 includes a check-in application 132, a service application 134, a database 136, and a network interface component 138. Check-in application 132 and service application 134 may correspond to processes, procedures, and/or applications executable by a hardware processor, for example, a software program. In other embodiments, service center server 130 may include additional or different software as required.

Check-in application 132 may correspond to processes to complete check-in with user device 110. Thus, check-in application 132 may correspond to the server side application of service center server 130 configured to transmit and/or receive a check-in request from user device 110 and complete the check-in request. The check-in request may include log in information for a user account in database 136 and thus complete the check-in with user 102 by verifying the account information. However, in embodiments where a user account has not been previously established by user 102 and/or service center server 130 does not offer user account services, check-in application 132 may receive other information for identifying user 102, include user name/identifier, user device identifier, a payment account/payment account identifier with payment provider server 160, or other information.

Once check-in is completed between user device 110 and service center server 130, check-in application 132 may be utilized to perform check-in with each merchant and/or service at service center 140, such as service 150. User 102 may be automatically checked-in to each service due to the initial check-in with service center server 130. However, in other embodiments, user 102 may only be checked-in to a service when user 102 is in proximity to the service. Check-in application 132 may complete the check-in processes by fulfilling check-in on behalf of service 150, such as completing a check-in process/application of service 150. For example, check-in application 132 may pass the check-in information to service 150 so that the user is checked-in with service 150. This can be done by accessing an API of a check-in application of service device 152 at service 150. However, in other embodiments, only an identifier of user 102/user device 110 may be passed to service 150 so that service 150 may recognize user 102 when user 102 is in proximity to wireless beacon 154. In such embodiments, service center server 130 may complete transactions using the check-in of user 102 on behalf of service 150.

Service center server 130 further includes service application 134. Service application 134 may be utilized to provide advertisements and updates to user device 110 for service 150, to complete transactions on behalf of service 150, and/or create a history of user 102 and alert user 102 when user 102 is in proximity to a preferred merchant. For example, service application 134 may transmit advertisements for merchants at service center 140, or may provide updates of services at service center 140, such as flight times, travel alerts, etc. The notifications transmitted to user device 110 may be specific to user 102, utilizing either a prior history of user 102 and/or known information about merchants/services of user 102. In other embodiments, service application 134 may be utilized to complete a transaction on behalf of service 150. The transaction may be completed by providing payment services for service 150. Thus, when user 102 wishes to purchase an item or service at service 150, user 102 may utilize user 110 to authorize a payment to service 150. User 102 and service center server 130 may further utilize payment provider server 160 to complete the transaction.

Service center server 130 further includes database 136 which may include, for example, identifiers such as operating system registry entries, cookies associated with check-in application 132 and/or service application 134, identifiers associated with hardware of service center server 130, or other appropriate identifiers, such as identifiers used for payment/user/device authentication or identification. Database 136 may include user accounts of user 102, which may comprise user personal information, user financial information, and/or an identifier for user 102 and/or user device 110. In various embodiments, identifiers in database 136 may be used by a payment/credit provider, such as payment provider server 160, to associate user 102 with a particular account maintained by the payment/credit provider. For example, an identifier for a payment account with payment provider server 160 may be stored with a user account or identifier of user 102 in database 136. In other embodiments, a user account stored in database 136 may include a shared identifier with the payment account with payment provider server 160.

In various embodiments, service center server 130 includes at least one network interface component 138 adapted to communicate with user device 110, service center server 130, service center 140 and/or payment provider server 160 over network 170. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service center 140 may correspond to a physical service center including a plurality of merchants and/or services. Service center 140 may correspond to a shopping mall, strip mall, airport, train station, event venue, hotel venue, casino venue, or other location where a plurality of merchants and/or services may be offered. Service center 140 may be one of a plurality of service centers corresponding to service center server 130. However, in other embodiments, service center server 130 may correspond only to service center 140. Service center 140 may include infrastructure for establishing a check-in for user device 110 with service center server 130 and/or completing check-in with user device 110 and one or more merchants/services offered in service center 140, such as service 150. For example, service center 140 may include wireless beacons, computer systems including processing and memory units, communication modules, and/or other necessary infrastructure.

Service center 140 includes a service 150, which may correspond to a merchant or service offered at service center 140. Service 150 may correspond to a physical location in service center 140. Additionally, service center 140 may include other features not pictured in FIG. 1, such as wireless beacons for communicating with user device 110 and establishing an initial connection with service center server 130, network connections to service center server 130, and other merchants and services.

Service 150 may be maintained, for example, by a merchant or seller offering various items, products, and/or services through a merchant location. Generally, service 150 may be maintained by anyone or any entity that receives money, which includes charities as well as retailers and restaurants. In other embodiments, service 150 may be maintained by an entity offering services to user 102, such as travel services, hotel/concierge services, food/restaurant services, or the like. In this regard, service 150 may include a device having processing applications, which may be configured to interact with user device 110 and/or payment provider server 140 to facilitate the sale of items/services and/or to update user 102 on items and/or services offered. Additionally, service 150 corresponds to an entity providing one or more wireless beacons providing check-in services to user 102. Thus, service 150 includes a service device 152 and a wireless beacon 154.

Service device 152 may be implemented using any appropriate hardware and software configured for wired and/or wireless communication with user device 110 and/or payment provider server 160. For example, in one embodiment, service device 152 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device. Although only one merchant device is shown, a plurality of merchant devices may be utilized.

Service device 152 may correspond to a device enabling service 150 to complete financial transactions, create and/or transmit advertisements and updates for display by user device 110, and/or utilize wireless beacon 154 to determine is user 102 is in proximity to service 150. Service device 152 may further include check-in applications configured to interact with check-in application 132 of service center server 130 to complete a check-in of user 102 with service 150 without user 102 being required to check-in directly with service 150. Check-in may be done as soon as user 102 checks-in with check-in application 132 or when user 102 is in proximity to service 150 and connects to wireless beacon 154. Service device 152 may include payment applications which may be configured to complete transactions for items. Transactions may be completed using payment provider server 160.

Wireless beacon 154 may be maintained, for example, by service 150. Wireless beacon 154 may be implemented using any appropriate hardware and software configured for wireless communication with user device 110. For example, in one embodiment, wireless beacon 154 may be implemented as a dongle device including a hardware processor and a communication module, for example, connected to service device 152. Thus, wireless beacon 154 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Wireless beacon 154 may also act as a stand-alone device including a processor, communication module, and/or network interface component configured to communicate with user device 110 and/or service center server 130. Although a single beacon is described, a plurality of wireless beacons may be utilized and be location specific within service 150.

Wireless beacon 154 of FIG. 1 contains processes, procedures, and/or applications executable by a hardware processor, for example, a software program, configured to interact with user device 110. Wireless beacon 154 may include applications for transmitting requests to establish a connection between a user device and a merchant. Thus, wireless beacon 154 may utilize a low energy short range wireless communication of wireless beacon 154 to transmit requests to establish a connection with user device 110, including an identifier such as a Universal Unique Identifier (UUID). If user device 110 receives the request to establish the connection and responds with a user device identifier (potentially including the UUID and other information to effectuate a check-in of user device 110), wireless beacon 132 may ramp up in power and create a connection between user device 110 and wireless beacon 154.

Wireless beacon 154 may transmit the request to establish the connection with wireless beacon 154 as a short range communication (e.g. a BLE protocol communication) including a “wake up” process for check-in application 120 of user device 110 and/or a token for wireless beacon 154 or service 150. The request may be specific to user device 110 by including information that is specific to user 102, such as a name, identifier, or user device identifier. The information specific to user 102 may be determined from a user account of user 102 or other information previously provided to service center server 130. Thus, in certain embodiments, only user device 110 will pick up and authenticate the request.

After wireless beacon 154 receives a user device identifier from user device 110, wireless beacon 154 may determine user 102 is in proximity to service 150. If check-in with service 150 has not previously been completed, than service device 152 may complete check in using check-in application 132 of service center server 130. Wireless beacon 154 (or service device 152 where wireless beacon 154 is connected to service device 152) may pass the user device identifier to service center server 130 to complete the check-in process. Additionally, wireless beacon 154 may keep a communication channel open between user device 110, service center server 130, service 150, and/or payment provider server 160 for passing additionally information, such as item, transaction, payment, or identification information.

Payment provider server 160 may be maintained, for example, by an online payment service provider, which may provide payment services and/or processing for financial transactions on behalf of a user with a merchant. In this regard, payment provider server 160 includes one or more processing applications which may be configured to interact with user device 110, service center server 130, and/or service 150 to facilitate payment for a transaction. In one example, payment provider server 160 may be provided by PayPal®, Inc. of San Jose, Calif., USA. However, in other embodiments, payment provider server 160 may be maintained by or include a credit provider, financial services provider, financial data provider, and/or other service provider, which may provide payment services to user 102.

Payment provider server 160 of FIG. 1 includes a transaction processing application 162, user accounts 164, and a network interface component 166. Transaction processing application 162 may correspond to processes, procedures, and/or applications executable by a hardware processor, for example, a software program. In other embodiments, payment provider server 160 may include additional or different software as required.

Transaction processing application 162 may be configured to receive and/or transmit information from user device 110, service center server 130, and/or service 150 for processing and completion of financial transactions. Transaction processing application 162 may include one or more applications to process financial transaction information from user device 110 and service 150 by receiving a request to complete a sale transaction for items/services/goods. The request may correspond to a payment from user device 110 to service center server 130 and/or service 150. The payment may include a user account identifier (e.g., a payment account for user 102 with payment provider server 160) or other payment information (e.g. a credit/debit card or checking account). Additionally, the payment may include a payment amount and terms of payment. Transaction processing application 162 may complete the sale transaction by providing payment to service center server 130 and/or service 150. Additionally, transaction processing application 162 may provide transaction histories, including receipts, to user device 110 and/or service 150 for completion and documentation of the financial transaction.

Additionally, payment provider server 160 may include user accounts 164. As previously discussed, user 102 may establish one or more user accounts with payment provider server 160. User accounts 164 may include user information, such as name, address, birthdate, payment/funding information, additional user financial information, and/or other desired user data. User 102 may link user accounts 164 to user device 110 through a user device identifier. Thus, when a device identifier corresponding to user device 110 is transmitted to payment provider server 160, e.g. from user device 110, service center server 130, and/or service 150, a user account belonging to user 102 may be found. However, in other embodiments, user 102 may not have previously established a user account. Thus, payment provider server 160 may complete a transaction based on another user financial account received from user device 110, service center server 130, and/or service 150.

In various embodiments, payment provider server 160 includes at least one network interface component 166 adapted to communicate with network 170 including user device 110, service center server 130, and/or service 150. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

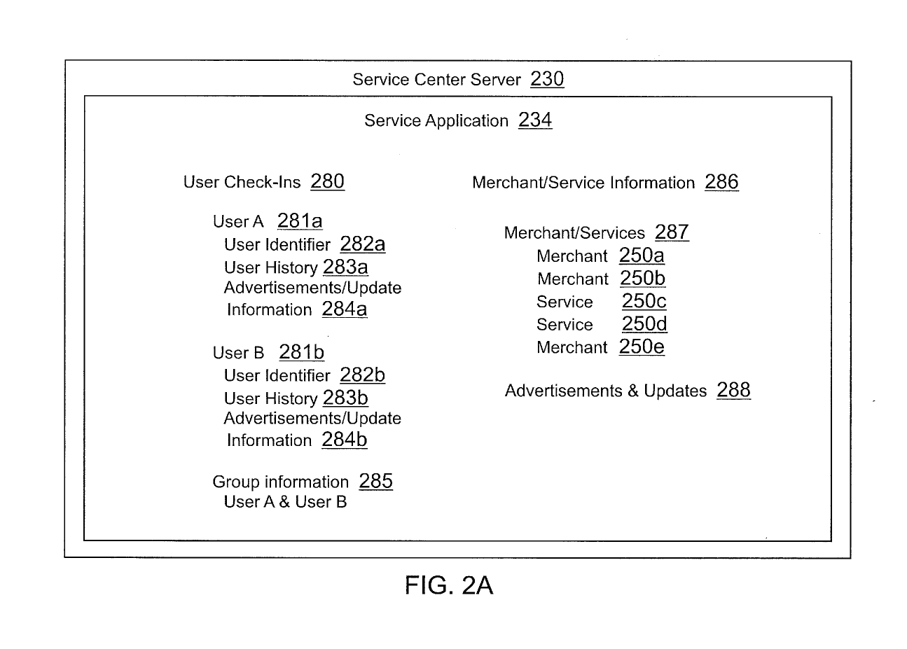

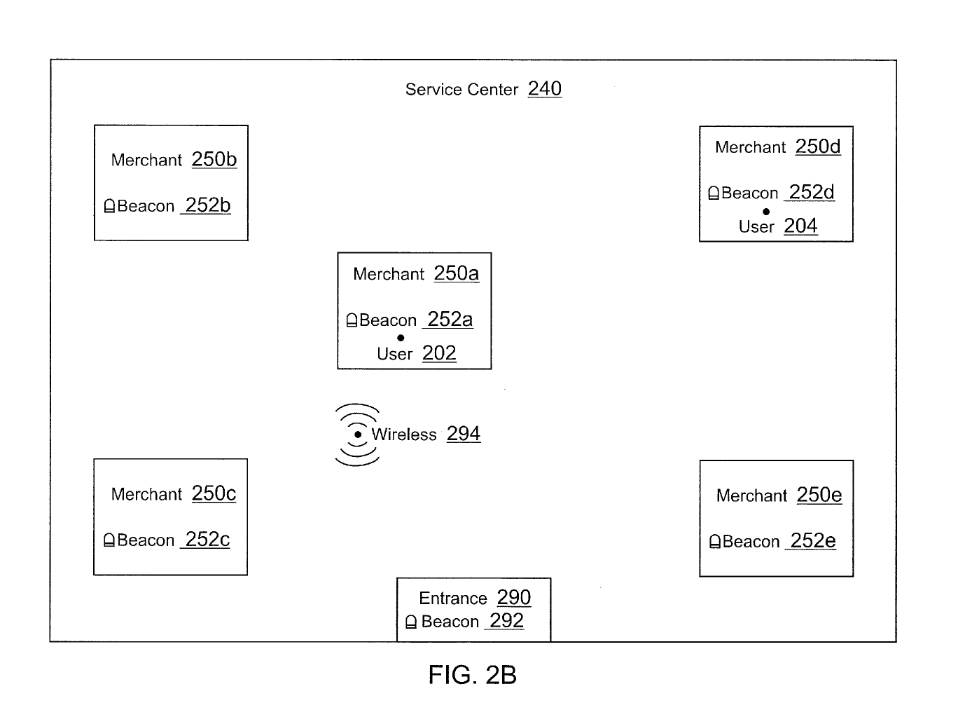

FIG. 2A is an exemplary server including information used to check-in a user with multiple services, according to an embodiment. FIG. 2A includes a service center servicer 230 and a service application 234 corresponding generally to service center server 230 and service application 234, respectively, of FIG. 1.

Shown in FIG. 2A is exemplary information/data utilized by service application 234 to complete a check-in with multiple services through a single check-in with service center server 230. In this regard, service application 234 includes user check-ins 280 and merchant/service information 286. User check-ins 280 may correspond generally to completed check-ins by a user using a user device with service center server 230. For example, a user may utilize a network connection to access service center server 230 over the Internet and complete a check-in with service center server 230. In other embodiments, the user may connect to a beacon at a service center corresponding to service center server 230 and complete the check-in through the beacon at the service center.

User check-ins 280 includes checked-in user A 281a and user B 282b. User A 281a and user B 281b may include information transmitted to service center server 230 at user check-in with service center server 230. Thus, user A 281a includes user identifier 282a, user history 283a, and advertisements/update information 284a, while user B 281b includes user identifier 282b, user history 283b, and advertisements/update information 284b. Additionally, user check-ins 280 includes group information 285 corresponding generally to group check-ins of two or more users and/or preferences by the two or more users to associate as a group.

User identifier 282a and 282b may correspond to a received user identifier on check-in with service center server 230, such as an identifier for user A 281a/user B 281b, a user device identifier for a user device of user A 281a/user B 281b, a user account identifier for user A 281a/user B 281b (including a payment account identifier with a payment provider server), and/or other user identifier. User identifier 282a and 282b may be utilized to determine user history 283a and 283b, respectively. For example, user identifiers 282a and 282b may be utilized to determine past check-ins with service center server 230 and/or merchants/services offered at a service center corresponding to service center server 230. Thus, a list of previous transactions and/or visited service locations may be determined and used for user histories 283a and 283b. Additionally, other information corresponding to user identifiers 282a and 282b may be retrieved from other sources, such as a server offering account services corresponding to user identifiers 282a and 282b (e.g., a payment history from a payment provider server).

Thus, service application 234 may determine user history 283a and 283b, which may then be utilized to determine preferred services at the service location, and offer advertisements, price discounts, and/or service information for the preferred services. Thus, advertisements/update information 284a and 284b may include advertisements and updates to push to a user device of user A 281a and user B 281b, respectively. In various embodiments, the updates are generally pushed to the user device for user A 281a and/or user B 281b or may be pushed to user A 281a and/or user B 281b when user A 281a and/or user B 281b are in communication with a beacon at the preferred service (and thus in proximity to the preferred service). In other embodiments, the preferred service may be notified of the presence of user A 281a and/or user b 281b at the service center so the preferred merchant/service may transmit information directly to user A 281a and/or user B 281b. The preferred service may transmit the information to user A 281a and/or user B 281b generally, or may transmit the information when user A 281a and/or user B 281b are in communication with a beacon at the preferred service (and thus in proximity to the preferred service).

Group information 285 may be utilized to provide group offerings (e.g., advertisements, discounts, and/or service information) to a group of users. User A 281a and user B 281b may associated as a group during check-in with service center server 230 (e.g., a group check in with multiple user identifiers and/or information for a second user's user identifier), or may select to associate as a group using service center server 230 (e.g., selection of another user using an application interface of service application 234). Thus, check-in information for user A 281a and user B 281b may be utilized to determine group information 285 through entered information on check-in or information received from user A 281a and/or user B 281b after check-in.

Service application 234 includes merchant/service information 286, which may be utilized to check-in user A 281a and user B 281b to one of merchant/service 287 and provide advertisement and updates 288 to user A 281a and user B 281b. Merchant/service 287 includes a list of available merchants/services at the service center, which may also include location information and/or beacon identifiers (or merchant/service identifiers used by the beacons). Information available under merchant/service 287 may be utilized to perform check-ins for user A 281a and user B 281b generally, or when in proximity to a beacon at one of merchant/service 287. Additionally, advertisements and updates 288 includes available advertisements and updates for the merchants/service in merchant/service 287, which may be pushed to user devices of user A 281a and/or user B 281b.

FIG. 2B is block diagram of an exemplary service center displaying two users checked-in to multiple services through a single check-in with a service center server, according to an embodiment. FIG. 2B includes a service center 240, which may correspond generally to service center 140 of FIG. 1.

Service center 240 of FIG. 2B displays a block diagram of a physical service center layout include a plurality of services available to users. In this regard, service center 240 includes a merchant 250a, a merchant 250b, a service 250c, a service 250d, and a merchant 250a. Additionally, service center 240 includes an entrance 290 having a beacon 292 and wireless 294.

As a user, such as user 202 visits service center 240, user 202 may establish a check-in generally with service center 240, such as through a server of service center 270. The check-in may be done through a network connection of a user device for user 202. In various embodiments, the user device includes network capabilities, such as a wireless communication network. However, the user device may also connect to wireless 294 at service center 240 to complete the check-in. In other embodiments, the user device may connect to beacon 292 when user 202 passes through entrance 290 to complete the check-in. For example, beacon 292 may utilize BLE communications to emit a short range wireless signal that initiates and completes a check-in with the user device when the user device is in proximity to beacon 292. The check-in/connection may be established as previously discussed with respect to wireless beacon 154 of FIG. 1. Thus, user 202 may be checked-in generally with service center 240.

Once checked-in to service center 240, user 202 may visit merchant 250a having a beacon 252a. User 202 may already be checked-in to merchant 250a, so that merchant 250a may view information for user 202, possess an identifier for user 202, and/or complete transactions with user 202 using the identifier. However, in other embodiments, a user device of user 202 may be required to be in range of beacon 252a so that a connection (e.g., using BLE or other communication protocol) is established between the user device and beacons 252a. The connection may be established as previously discussed with respect to wireless beacon 154 of FIG. 1. The check-in with merchant 250a may be performed without any user input. Thus, user 202 may be automatically checked-in to services user 202 visits at service center 240. Merchant 250a may then transmit information and/or complete transactions with user 202.

User 202 may have a preferred merchant 250b, such as a merchant that user 202 frequents. Thus, user 202 may receive advertisements, discount offers, or other offerings from merchant 250b. Merchant 250b and/or a server for service center 240 may generally transmit these offerings to user 202 (e.g., over the Internet and/or through wireless 294), or user 202 may be required to establish a connection first with beacon 252b, as previously discussed.

Additionally, user 202 may be required to utilize a more general service, such as service 250c. Service 250c may correspond to a transportation service, health service, etc., that may provide schedules and/or updates to user 202. Thus, service 250c and/or a server for service center 240 may generally transmit these offerings to user 202 (e.g., over the Internet and/or through wireless 294), or user 202 may be required to establish a connection first with beacon 252c, as previously discussed.

User 202 may also be grouped with user 204. User 204 may be at service 250d, potentially checked-in and completing a transaction utilizing beacon 252d. Merchant 250a may offer a group discount for items to user 202 and user 204. Thus, user 202 and user 204 may receive the group discount generally or users 202 and 204 may be required to establish a connection first with beacon 252e, as previously discussed. In various embodiments, both user 202 and user 204 may be required to establish a connection with beacon 252e first before the group discount may be redeemed.

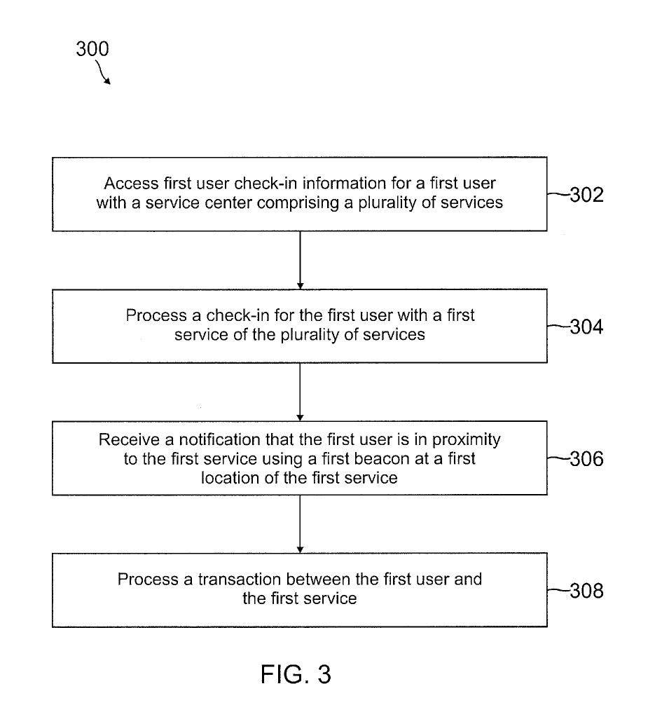

FIG. 3 is a flowchart of an exemplary process by a service center server for completing a check-in for multiple services, according to an embodiment. Note that one or more steps, processes, and methods described herein may be omitted, performed in a different sequence, or combined as desired or appropriate.

At step 302, first user check-in information is accessed for a first user with a service center comprising a plurality of services. The check-in information may correspond to a user identifier, a user history, or other information transmitted by the first user to a service center server and/or determined by the service center on check-in of the first user using the service center server.

At step 304, a check-in for the first user with a first service of the plurality of services is processed. The check-in with the first service may be processed generally after the first user check-in information is transmitted to the service center server. In other embodiments, the check-in may be processed when the first user is in proximity to the first service, such as in range of a beacon to establish a connection with the beacon.

A notification that the first user is in proximity to the first service may be received using a beacon at a location of the first service, at step 306. The beacon may communicate with a user device of the first user. The beacon may communicate with the user device using one of near field communication, radio communication, infrared communication, Bluetooth communication, and Bluetooth low energy communication.

The beacon may transmit one of an advertisement, a price discount, and service information corresponding to the first service to the first user. In other embodiments, one of an advertisement, a price discount, and service information may be transmitted to the first user using a server for the service center. Additionally, a list of service locations visited by the first user may be determined using the first user check-in information. Thus, a history for a user may be determined using the history and/or transactions completed by the first user. The history may be accessed to determine if one or more services is a preferred service, and to transmit one of an advertisement, a price discount, and service information to the first user for the preferred service.

At step 308, a transaction between the first user and the first service is processed. The transaction may correspond to a sale, informational query, or other informational exchange between the first service and the first user. In various embodiments, a purchase request may be received for an item or service at one of the plurality of services prior to the first user visiting the service. Thus, the service may provide the item or service when the user is detected at the service using a beacon at the service. Additionally, the transaction/purchase request may be processed using a payment account of the first user with a payment provider. Where the first service corresponds to a service used by the first user (e.g., transportation services, health services, or other services that may involve scheduling and/or informational updates to the first user), the transaction may correspond to informational updates transmitted to the first user.

In various embodiments, second user check-in information for a second user with the service center may be accessed. Thus, the service center service may determine if the first user and the second user are in a group using the first user check-in information and the second user check-in information. If the first user and the second user are in a group, the first user and the second user may receive group offerings from one of the services.

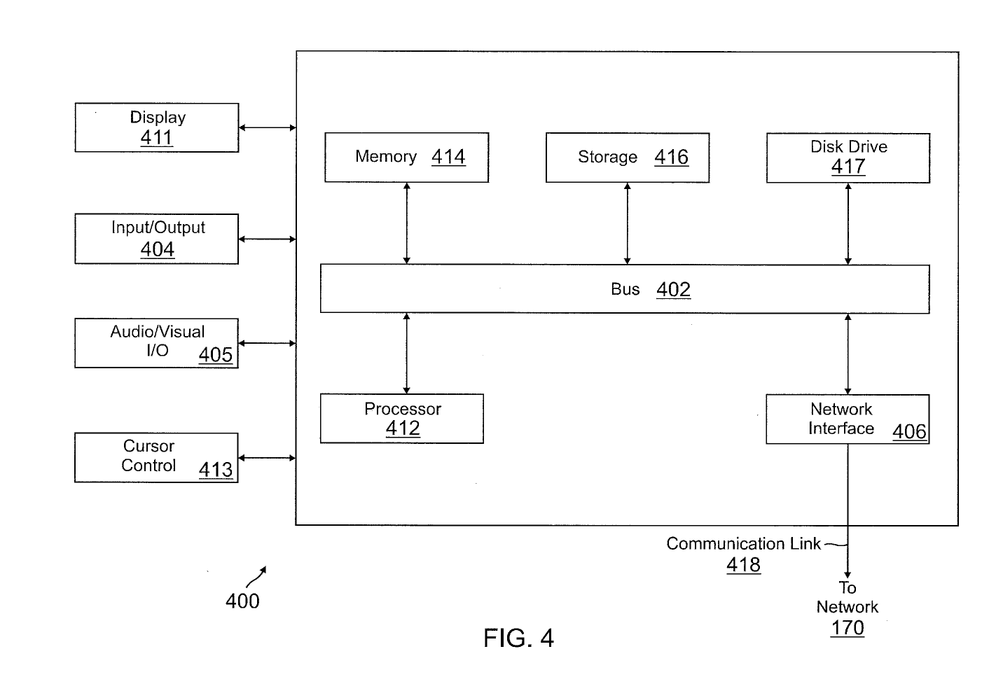

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a service provider server via network 170. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing service center information for a plurality of services; and
one or more hardware processors in communication with the non-transitory memory and configured to:
access first user check-in information for a first user with a service center comprising the plurality of services;
process a check-in for the first user with a first service of the plurality of services;
receive a notification that the first user is in proximity to the first service using a beacon at a location of the first service; and
process a transaction between the first user and the first service.

2. The system of claim 1, wherein the beacon communicates with a user device of the first user.

3. The system of claim 2, wherein the beacon communicates with the user device using one of near field communication, radio communication, infrared communication, Bluetooth communication, and Bluetooth low energy communication.

4. The system of claim 1, wherein the beacon transmits one of an advertisement, a price discount, and service information corresponding to the first service to the first user.

5. The system of claim 1, wherein the one or more hardware processors is further configured to:
access a list of service locations visited by the first user, wherein the list of service locations is determined using the first user check-in information; and
determine a history for the first user based on at least one of the transaction and the list of the service locations visited by the first user.

6. The system of claim 5, wherein the one or more hardware processors is further configured to:
determine if a second service of the plurality of services is a preferred service of the first user based on the history; and
transmit one of an advertisement, a price discount, and service information to the first user for the second service if the second service is a preferred service.

7. The system of claim 1, wherein the one or more hardware processors is further configured to:
receive a purchase request for an item or service from the first service,
wherein the one or more hardware processors is further configured to process the transaction by:
processing the purchase request with the first service, wherein the first service provides the item or the service to the first user on detection of the first user device in proximity to the beacon at the location of the first service.

8. The system of claim 1, wherein the one or more hardware processors is further configured to:
determine if the first user utilizes the first service using the first user check-in information, and
wherein the one or more hardware processors is further configured to process the transaction by:
transmitting updates for the first service to the first user if the first user utilizes the first service.

9. The system of claim 1, wherein the transaction is completed using a payment account of the first user with a payment provider.

10. The system of claim 1, wherein the one or more hardware processors is further configured to:
access second user check-in information for a second user with the service center; and
determine if the first user and the second user are in a group using the first user check-in information and the second user check-in information.

11. The system of claim 10, wherein the one or more hardware processors is further configured to:
transmit the first user check-in information and the second user check-in information to a service of the plurality of services if the first user and the second user are in the group, wherein the service transmits group offerings to the first user and the second user.

12. A method comprising:
accessing first user check-in information for a first user with a service center comprising a plurality of services;
processing a check-in for the first user with a first service of the plurality of services;
receiving a notification that the first user is in proximity to the first service using a beacon device at a location of the first service; and
processing, using one or more hardware processors of a server, a transaction between the first user and the first service.

13. The method of claim 12, wherein the beacon transmits one of an advertisement, a price discount, and service information corresponding to the first service to the first user.

14. The method of claim 12 further comprising:
accessing a list of service locations visited by the first user, wherein the list of service locations is determined using the first user check-in information; and
determining a history for the first user based on at least one of the transaction and the list of the service locations visited by the first user.

15. The method of claim 14 further comprising:
determining if a second service of the plurality of services is a preferred service of the first user based on the history; and
transmitting one of an advertisement, a price discount, and service information to the first user for the second service if the second service is a preferred service.

16. The method of claim 12 further comprising:
receiving a purchase request for an item or service from the first service,
wherein the processing the transaction comprises:
processing the purchase request with the first service, wherein the first service provides the item or the service to the first user on detection of the first user device in proximity to the beacon device at the location of the first service.

17. The method of claim 12 further comprising:
determining if the first user utilizes the first service using the first user check-in information, and
wherein the processing the transaction comprises:
transmitting updates for the first service to the first user if the first user utilizes the first service.

18. The method of claim 12, wherein the transaction is processed using a payment account of the user with a payment provider.

19. A non-transitory computer readable medium comprising a plurality of machine-readable instructions which when executed by one or more processors of a server are adapted to cause the server to perform a method comprising:
accessing first user check-in information for a first user with a service center comprising a plurality of services;
processing a check-in for the first user with a first service of the plurality of services;
receiving a notification that the first user is in proximity to the first service using a beacon at a location of the first service; and
processing a transaction between the first user and the first service.

20. The non-transitory computer readable medium of claim 19, wherein the beacon transmits one of an advertisement, a price discount, and service information corresponding to the first service to the first user.
